(19) United States
(12) Patent Application Publication
(10) Pub. No.: US 2013/0248627 A1
(43) Pub. Date: Sep. 26, 2013

(54) FOOD PROCESSOR WITH A SAFETY DESIGN

(71) Applicants: Chih-Hung HUANG, Guangdong (CN); Bo-Min REN, Guangdong (CN)

(72) Inventors: Chih-Hung HUANG, Guangdong (CN); Bo-Min REN, Guangdong (CN)

(21) Appl. No.: 13/551,993

(22) Filed: Jul. 18, 2012

(30) Foreign Application Priority Data
Mar. 23, 2012 (CN) 201220131619.2

(51) Int. Cl. B02C 23/04

(52) U.S. Cl. 241/36

(57) ABSTRACT

A food processor with a safety design includes a cover, a container consisting of a container body, a blade, a first electrical connector, a low-level sensor, a high-level sensor and a cover sensor, and a base holding therein a second electrical connector, a driving module, a heating module and a control unit. When the base and the container are assembled and the cover is closed on the container body, the second electrical connector is connected to the first electrical connector, and the driving module is coupled with the blade. The control unit receives sensing signals from the low-level sensor, the high-level sensor and the cover sensor, and drives the driving module to rotate the blade and the heating module to heat an accommodation chamber of the container body subject to the sensing signals.

### BACKGROUND OF THE INVENTION

1. Field of the Invention

The present invention relates to an electrical kitchen appliance used to facilitate food processing and more particularly, to a food processor with a safety design.

2. Description of the Related Art

The safety design of a conventional fruit juicer is the installation of a trigger switch in the base thereof. When the jar of the fruit juicer is installed in the base, the bottom of the jar triggers the trigger switch, conducting electricity to the motor in the base.

Fruit juicers with a heating module are known. A fruit juicer with a heating module can heat the extracted fruit juice in the housing. U.S. Pat. No. 7,780,337 discloses a similar design, entitled “Blend soup maker”. However, if the electrical heating tube on the bottom of the jar is turned on to heat food in the jar as food in the jar is below a specific low level, the jar may be burned out, leading to hazardous situations.

### SUMMARY OF THE INVENTION

The present invention has been accomplished under the circumstances in view. It is the main object of the present invention to provide a food processor with a safety design, which effectively measures the safety level of the foods therein, avoiding a non-load burning accident.

It is another object of the present invention to provide a food processor with a safety design, which accurately detects the closing or unclosing status of the cover, avoiding accidental finger injury.

To achieve these and other objects of the present invention, a food processor with a safety design comprises a cover, a container, and a base. The container comprises a container body, a blade, a handle, a first electrical connector, a low-level sensor, a high-level sensor and a cover sensor. The container body comprises an accommodation chamber, and an opening in communication with the accommodation chamber. The blade is rotatably mounted in the accommodation chamber. The handle is mounted at the container body. The first electrical connector is mounted in a bottom wall of the handle. The low-level sensor is mounted in a bottom side of the handle and inserted into the accommodation chamber of the container body adjacent to the blade, and electrically connected to the first electrical connector. The high-level sensor is mounted in a top side of the handle and inserted into the accommodation chamber of the container body adjacent to the opening, and electrically connected to the first electrical connector. The cover sensor is electrically connected to the first electrical connector for sensing whether or not the cover is closed on the opening of the container body.

The base is assembled with the container, comprising a second electrical connector, a driving module, a heating module and a control unit. The second electrical connector, the driving module and the heating module are respectively electrically coupled to the control unit. The control unit is adapted for controlling the operation of the driving module and the heating module. The second electrical connector is electrically connected to the first electrical connector when the base and the container are assembled together. The driving module is connected with the blade. The control unit is adapted to receive sensing signals from the low-level sensor, the high-level sensor and the cover sensor, and to drive the driving module to rotate the blade and the heating module to heat the accommodation chamber of the container body subject to the sensing signals.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a food processor in accordance with the present invention.

FIG. 2 is a sectional view of the food processor in accordance with the present invention.

FIG. 3 is an elevational view of the present invention, illustrating the cover removed from the container.

FIG. 4 is a cutaway view, in an enlarged scale, of the base of the food processor in accordance with the present invention.

FIG. 5 is an exploded view of the container of the food processor in accordance with the present invention.

FIG. 6 is a schematic drawing illustrating the low-level sensor installed in the container body of the container of the food processor in accordance with the present invention.

FIG. 7 is a schematic sectional view of the low-level sensor of the food processor in accordance with the present invention.

### DETAILED DESCRIPTION OF THE INVENTION

The invention will be described hereinafter by way of example with reference to the annexed drawings.

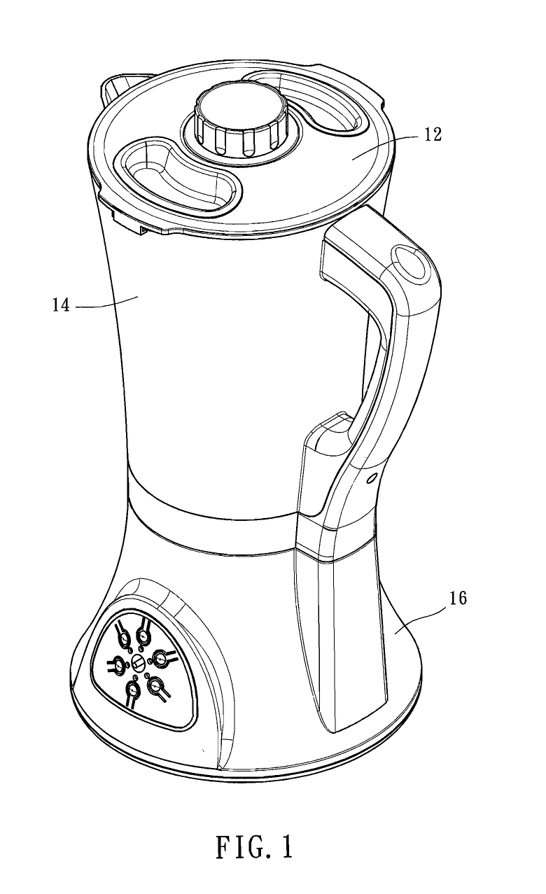

Referring to FIGS. 1-7, a food processor with a safety design in accordance with the present invention is shown for cutting, stirring and mixing food, such as vegetables, fruits and corns into a juice or paste. The food processor comprises a cover 12, a container 14 and a base 16.

The cover 12 and the container 14 are normally made of food grade plastics or glass.

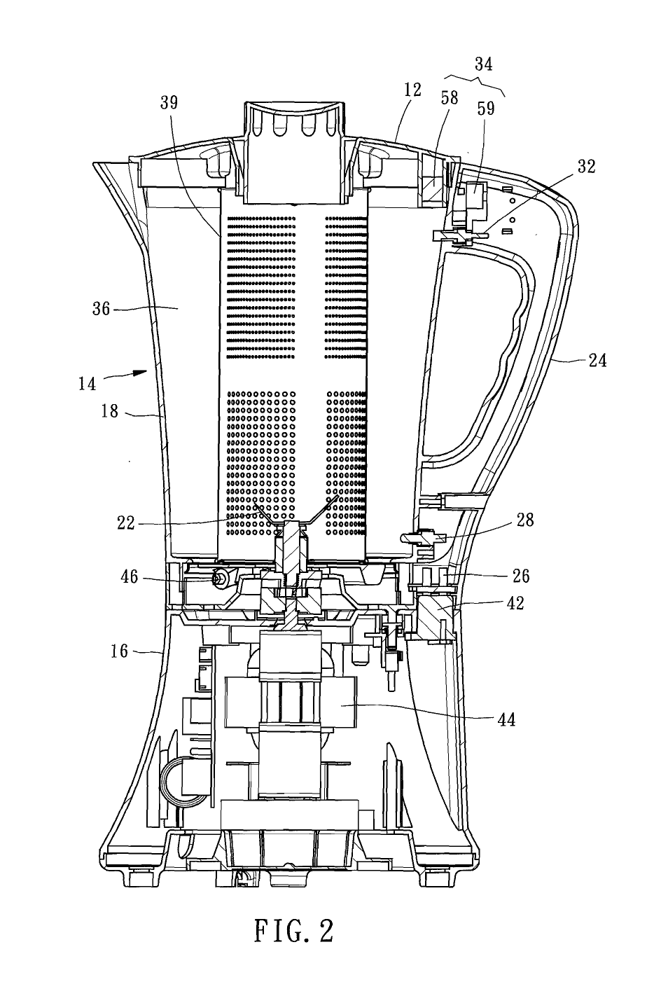

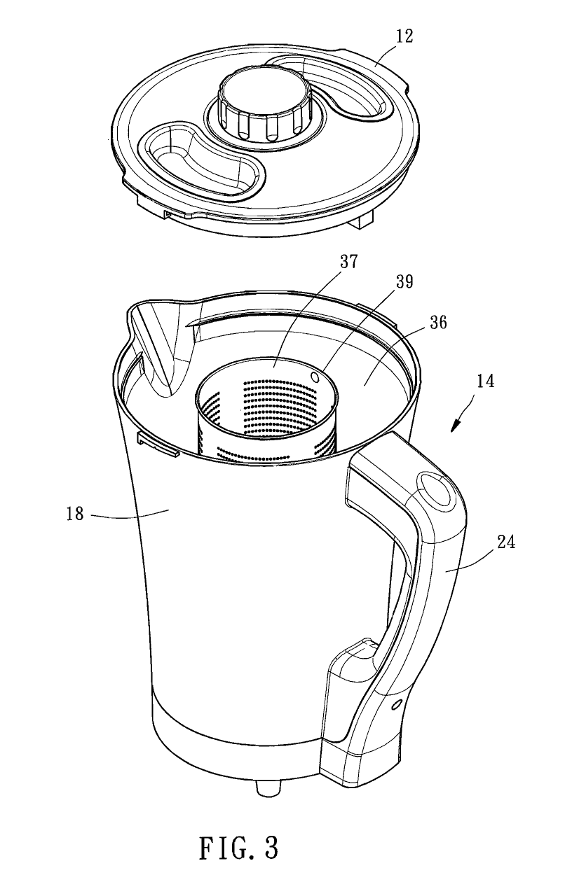

As shown in FIG. 2 and FIG. 3, the container 14 comprises a container body 18, a blade 22, a handle 24, a first electrical connector 26, a low-level sensor 28, a high-level sensor 32, and a cover sensor 34. The container body 18 defines an accommodation chamber 36, and an opening 37 in communication with the accommodation chamber 36. Vegetables, fruits, corn and other foods can be put through the opening 37 of the container body 18 into the accommodation chamber 36 and temporarily stored therein. In this embodiment, a strainer basket 39 is set in the container body 18 within the accommodation chamber 36 for filtering food residue. In actual practice, the strainer basket 39 can be omitted. The blade 22 is rotatably mounted in the container body 18 within the accommodation chamber 36. In this embodiment, the blade 22 is positioned in the strainer basket 39. If the strainer basket 39 is omitted, the blade 22 shall be directly mounted in the accommodation chamber 36 of the container body 18. The handle 24 is mounted at the container body 18. The first electrical connector 26 is mounted in the bottom wall of the handle 24, as shown in FIG. 3. The low-level sensor 28 is mounted in the bottom side of the handle 24 and electrically connected to the first electrical connector 26. Further, the low-level sensor 28 is inserted into the accommodation chamber 36 of the container body 18, and disposed adjacent to the blade 22. The high-level sensor 32 is mounted in the top side of the handle 24 and electrically connected to the first electrical connector 26. Further, the high-level sensor 32 is inserted into the accommodation chamber 36 of the container body 18, and disposed adjacent to the opening 37. The cover sensor 34 is electrically connected to the first electrical connector 26 for sensing whether or not the cover 12 is closed on the opening 37 of the container body 18.

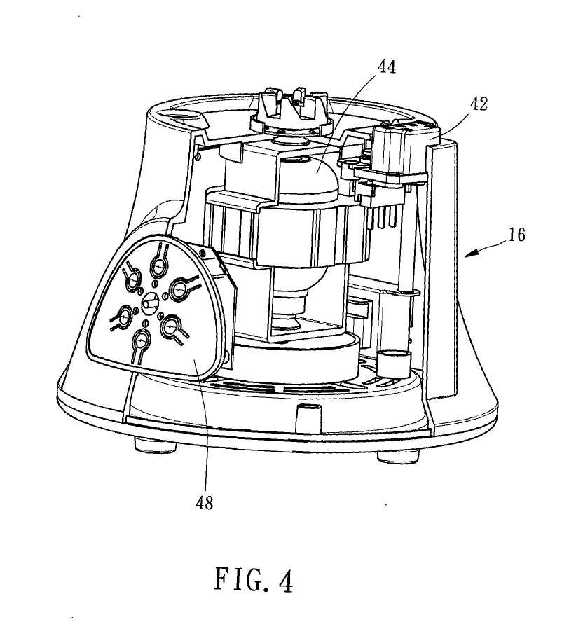

Referring to FIG. 2 and FIG. 4, the base 16 is assembled with the container 14, comprising a second electrical connector 42, a driving module 44, a heating module 46, and a control unit 48. The second electrical connector 42, the driving module 44 and the heating module 46 are respectively electrically coupled to the control unit 48. The control unit 48 is adapted for controlling the operation of the driving module 44 and the heating module 46. In this embodiment, the first electrical connector 26 is an electrical plug; the second electrical connector 42 is an electrical socket. When assembling the base 16 and the container 14, the second electrical connector 42 is electrically connected to the first electrical connector 26. The driving module 44 is connected with the blade 22. At this time, the low-level sensor 28, the high-level sensor 32 and the cover sensor 34 are electrically coupled to the control unit 48, enabling a sensing result to be transmitted to the control unit 48. Thus, subject to this sensing result, the control unit 48 can drive the driving module 44 to rotate the blade 22, and/or the heating module 46 to heat the accommodation chamber 36 of the container body 18.

The low-level sensor 28 and the high-level sensor 32 can be selected from the group of water level sensors and interrupter sensors.

When the level of the foods in the accommodation chamber 36 of the container body 18 is below the elevation of the low-level sensor 28, the low-level sensor 28 provides a sensing signal to the control unit 48, causing the control unit 48 to stop the heating module 46 from heating the accommodation chamber 36, avoiding a non-load burning accident. When the level of the foods in the accommodation chamber 36 of the container body 18 surpasses the elevation of the high-level sensor 32, the high-level sensor 32 provides a sensing signal to the control unit 48, causing the control unit 48 to drive the heating module 46 in heating the accommodation chamber 36, and to generate a visual or audio prompt signal.

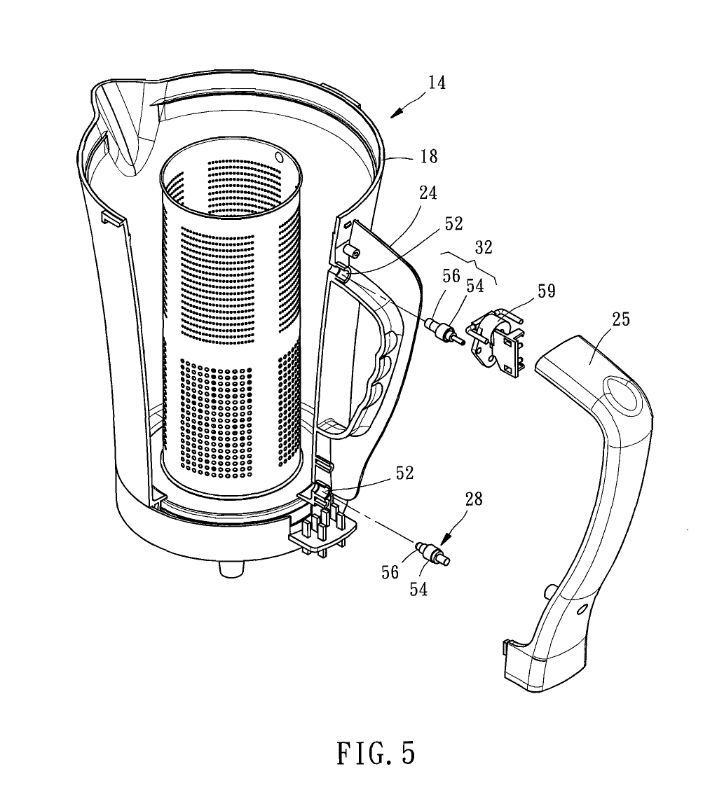

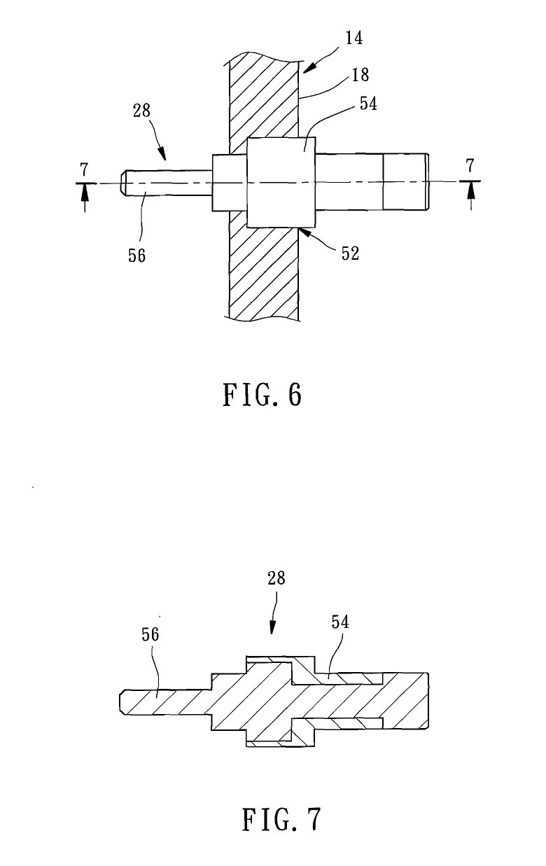

Referring to FIG. 5, the container body 18 of the container 14 further comprises two pivot holes 52. The low-level sensor 28 and the high-level sensor 32 each comprise a sealing jacket 54 and a sensor element 56. In FIGS. 6 and 7, only the low-level sensor 28 is described. The sealing jacket 54 is positioned in one pivot hole 52 in such a manner that the outside wall of the sealing jacket 54 is tightly abutted against the wall of the pivot hole 52. The sensor element 56 is inserted through sealing jacket 54. By means of the sealing jacket 54, the sensor element 56 is firmly secured to the pivot hole 52, preventing leaking of fluid out of the accommodation chamber 36 of the container body 18. The structure and installation method of the high-level sensor 32 are same as that of the low-level sensor 28. Further, the handle 24 is covered by a sheath 25 that shields the low-level sensor 28, the high-level sensor 32 and the cover sensor 34. However, the handle 24 can be configured to shield the low-level sensor 28, the high-level sensor 32 and the cover sensor 34 without the aforesaid sheath 25.

Referring to FIG. 2, the cover sensor 34 senses the closed status of the cover 12 by means of magnetic sensing. The cover sensor 34 comprises a sensible end 58 and a sensing end 59. The sensible end 58 is positioned in the cover 12. The sensing end 59 is positioned in the top side of the handle 24. The cover sensor 34 can be a variable reluctance sensor (VRS), linear variable differential transformer (LVDT), or other magnetic sensor. If the cover 12 is not closed, the cover sensor 34 provides a sensing signal indicative of the unclosing condition of the cover 12 to the control unit 48. Subject to this sensing signal, the control unit 48 does not drive the driving module 44 to rotate the blade 22, preventing the operator's fingers being inserted into the accommodation chamber 36 of the container body 18 from injury.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A food processor, comprising:
a cover;
a container, said container comprising a container body, a blade, a handle, a first electrical connector, a low-level sensor, a high-level sensor and a cover sensor, said container body comprising an accommodation chamber and an opening in communication with said accommodation chamber, said blade being rotatably mounted in said container body within said accommodation chamber, said handle being mounted at said container body, said first electrical connector being mounted in said handle in a bottom wall thereof, said low-level sensor being mounted in a bottom side of said handle and inserted into said accommodation chamber of said container body adjacent to said blade and electrically connected to said first electrical connector, said high-level sensor being mounted in a top side of said handle and inserted into said accommodation chamber of said container body adjacent to said opening and electrically connected to said first electrical connector, said cover sensor being electrically connected to said first electrical connector for sensing whether or not the cover is closed on the opening of the container body; and
a base supporting said container, said base comprising a second electrical connector, a driving module, a heating module and a control unit, said second electrical connector, said driving module and said heating module being respectively electrically coupled to said control unit, said control unit being adapted for controlling the operation of said driving module and said heating module, said second electrical connector being electrically connected to said first electrical connector when said base and said container are assembled together, said driving module being connected with said blade, said control unit being adapted to receive sensing signals from said low-level sensor, said high-level sensor and said cover sensor and to drive said driving module to rotate said blade and said heating module to heat said accommodation chamber of said container body subject to the sensing signals.

2. The food processor as claimed in claim 1, wherein said container body of said container comprises two pivot holes; said low-level sensor and said high-level sensor each comprises a sealing jacket and a sensor element, the sealing jackets of said low-level sensor and said high-level sensor being respectively positioned in said pivot holes and tightly abutted against respective walls of the respective pivot holes, the sensor elements of said low-level sensor and said high-level sensor being respectively inserted through the respective sealing jackets.

3. The food processor as claimed in claim 1, wherein said cover sensor detects the position of said cover by magnetic sensing.

4. The food processor as claimed in claim 3, wherein said cover sensor comprises a sensible end positioned in said cover, and a sensing end positioned in the top side of said handle.
